(19) United States
(12) Patent Application Publication
(10) Pub. No.: US 2011/0003522 A1
(43) Pub. Date: Jan. 6, 2011

(54) BIO-BASED AQUEOUS BINDER FOR FIBERGLASS INSULATION MATERIALS AND NON-WOVEN MATS

(76) Inventors: Liang Chen, New Albany, OH (US); William E. Downey, Granville, OH (US); Jesus M. Hernandez-Torres, Pataskala, OH (US)

Correspondence Address: OWENS CORNING, 2790 COLUMBUS ROAD, GRANVILLE, OH, 43023, US

(21) Appl. No.: 12/776,703

(22) Filed: May 10, 2010

Related U.S. Application Data
(60) Provisional application No. 61/178,745, filed on May 15, 2009.

(51) Int. Cl. E04B 1/74; C09K 3/00; D04H 13/00

(52) U.S. Cl. 442/59; 252/62; 252/182.12

(57) ABSTRACT

An aqueous binder composition is provided that includes a protein-containing biomass and a pH adjuster. Optionally, a crosslinking agent and/or a moisture resistant agent may be included in the binder composition. The protein-containing biomass is natural in origin and may be derived from plant or animal sources. The pH adjuster is used to adjust the pH of the binder to a desired pH and lower the viscosity of the protein-based biomass. In addition, the pH adjuster may act as a crosslinking agent. The crosslinking agent may be any compound suitable for crosslinking the protein-containing biomass and reacting with the moisture resistant agent, when the moisture resistant agent is present in the binder. In addition, the binder has a light color after it has been cured. The environmentally friendly, formaldehyde-free binder may be used in the formation of insulation materials and non-woven chopped strand mats.

### CROSS-REFERENCE TO RELATED APPLICATIONS

This application is related to and claims domestic priority benefits from U.S. Provisional Patent Application Ser. No. 61/178,745 entitled “Bio-based Aqueous Binder For Fiberglass Insulation Materials And Non-Woven Mats” filed May 15, 2009, the entire content of which is expressly incorporated herein by reference in its entirety.

### TECHNICAL FIELD AND INDUSTRIAL APPLICABILITY OF THE INVENTION

The present invention relates generally to rotary fiber insulation and non-woven mats, and more particularly, to a binder for use in manufacturing both fiberglass insulation and non-woven mats that is protein-based, free of formaldehyde, and environmentally friendly.

### BACKGROUND OF THE INVENTION

Conventional fibers are useful in a variety of applications including reinforcements, textiles, and acoustical and thermal insulation materials. Although mineral fibers (e.g., glass fibers) are typically used in insulation products and non-woven mats, depending on the particular application, organic fibers such as polypropylene, polyester, and multi-component fibers may be used alone or in combination with mineral fibers in forming the insulation product or non-woven mat.
Fibrous insulation is typically manufactured by fiberizing a molten composition of polymer, glass, or other mineral and spinning fine fibers from a fiberizing apparatus, such as a rotating spinner. To form an insulation product, fibers produced by the rotating spinner are drawn downwardly from the spinner towards a conveyor by a blower. As the fibers move downward, a binder material is sprayed onto the fibers and the fibers are collected into a high loft, continuous blanket on the conveyor. The binder material gives the insulation product resiliency for recovery after packaging and provides stiffness and handleability so that the insulation product can be handled and applied as needed in the insulation cavities of buildings. The binder composition also provides protection to the fibers from interfilament abrasion and promotes compatibility between the individual fibers.

The blanket containing the binder-coated fibers is then passed through a curing oven and the binder is cured to set the blanket to a desired thickness. After the binder has cured, the fiber insulation may be cut into lengths to form individual insulation products, and the insulation products may be packaged for shipping to customer locations. One typical insulation product produced is an insulation batt or blanket, which is suitable for use as wall insulation in residential dwellings or as insulation in the attic and floor insulation cavities in buildings. Another common insulation product is air-blown or loose-fill insulation, which is suitable for use as sidewall and attic insulation in residential and commercial buildings as well as in any hard-to-reach locations. Loose-fill insulation is formed of small cubes that are cut from insulation blankets, compressed, and packaged in bags.

Non-woven mats may be formed by conventional wet-laid processes. For example, wet chopped fibers are dispersed in a water slurry that contains surfactants, viscosity modifiers, defoaming agents, and/or other chemical agents. The slurry containing the chopped fibers is then agitated so that the fibers become dispersed throughout the slurry. The slurry containing the fibers is deposited onto a moving screen where a substantial portion of the water is removed to form a web. A binder is then applied, and the resulting mat is dried to remove any remaining water and cure the binder. The formed non-woven mat is an assembly of dispersed, individual glass filaments.

Various attempts have been made to reduce undesirable formaldehyde emissions from formaldehyde-based resins. For example, various formaldehyde scavengers such as ammonia and urea have been added to the formaldehyde-based resin in an attempt to reduce formaldehyde emission from the insulation product. Because of its low cost, urea is added directly to the uncured resin system to act as a formaldehyde scavenger. The addition of urea to the resin system produces urea-extended phenol-formaldehyde resole resins. These resole resins can be further treated or applied as a coating or binder and then cured. Unfortunately, the urea-extended resoles are unstable, and because of this instability, the urea-extended resoles must be prepared on site. In addition, the binder inventory must be carefully monitored to avoid processing problems caused by undesired crystalline precipitates of dimer species that may form during storage Ammonia is not a particularly desirable alternative to urea as a formaldehyde scavenger because ammonia generates an unpleasant odor and may cause throat and nose irritation to workers. Further, the use of a formaldehyde scavenger in general is undesirable due to its potential adverse affects to the properties of the insulation product, such as lower recovery and lower stiffness.

In addition, previous arts have focused on the use of polyacrylic acid with a polyhydroxy crosslinking agent or carbohydrate-based chemistry that is linked to the Maillard reaction. Polyacrylic acid inherently has problems due to its acidity and associated corrosion of machine parts. In addition, polyacrylic acid binders have a high viscosity, high curing temperatures, and high associated curing costs. Further, the Maillard-based products have an undesirable dark brown color after curing. Also, the use of large amounts of ammonia needed to make the binder presents a safety risk and possible emission problems.

Alternative polymeric binder systems to those described above for fibrous glass products have also been proposed. However, these alternative binder systems remain problematic. For example, low molecular weight, low viscosity binders which allow maximum vertical expansion of the insulation pack in the transfer zone generally cure to form a non-rigid plastic matrix in the finished product, thereby reducing the attainable vertical height recovery of the finished insulation product when installed. Conversely, high viscosity binders, which generally cure to form a rigid matrix in the finished product, do not allow the desired maximum vertical expansion of the coated, uncured pack.

In view of the existing problems with current binders, there remains a need in the art for a binder system that does not corrode machine parts, does not emit formaldehyde, and which is environmentally.

### SUMMARY OF THE INVENTION

It is an object of the present invention to provide a binder composition for use in the formation of fiberglass insulation and non-woven chopped strand mats that includes a protein based biomass derived from natural sources and a pH adjusting agent. In exemplary embodiments, the protein-based biomass may be derived from soy, peanuts, sunflowers, kidney beans, walnuts, eggs, blood, meat, and/or fish. Additionally, the protein-containing biomass may contain up to about 95% protein. The pH adjuster is utilized to adjust the pH of the binder composition to a desired acidic (e.g., about 1 to about 6), basic (e.g., about 8 to about 14), or neutral pH (e.g., about 7). The pH adjuster may be selected from citric acid, acetic acid, sulfuric acid, sodium bisulfate, sodium hydroxide, potassium hydroxide, ammonium hydroxide, and the like. The binder composition may also include a crosslinking agent and/or a moisture resistant agent. The inventive binder composition cures at a temperature that is lower than a curing temperature of a conventional formaldehyde-based binder, thereby reducing manufacturing costs and gaseous emissions.

It is another object of the present invention to provide a fibrous insulation product that includes a plurality of randomly oriented fibers and a binder composition applied to at least a portion of the fibers and interconnecting the fibers. The binder includes a protein-based biomass derived from natural sources and a pH adjusting agent that is used to adjust the pH of said binder composition to a pH from 1 to 14. The pH of the binder composition, when in an acidic state, may range from about 1 to about 6, and when in a basic state, may range from about 8 to about 14. In exemplary embodiments, the protein-containing biomass may contain up to about 95% protein. The protein-based biomass may be derived from soy, peanuts, sunflowers, kidney beans, walnuts, eggs, blood, meat, and/or fish. The binder composition may also include a crosslinking agent and/or a moisture resistant agent. The binder composition cures at a temperature that is lower than a curing temperature of a conventional formaldehyde-based binder, thereby reducing manufacturing costs. In addition, the binder composition has a light color upon curing, unlike conventional formaldehyde binder compositions.

It is yet another object of the present invention to provide a non-woven chopped strand mat formed of a plurality of randomly oriented glass fibers having a discrete length enmeshed in the form of a mat having a first major surface and a second major surface and a binder composition at least partially coating said first major surface of said mat. The binder includes a protein-based biomass derived from natural sources and a pH adjusting agent. The protein-based biomass is natural in origin and derived from renewable resources, such as from plants and animals. In exemplary embodiments, the protein-based biomass may be derived from soy, peanuts, sunflowers, kidney beans, walnuts, eggs, blood, meat, and/or fish. Additionally, the protein-containing biomass may contain up to about 95% protein. The binder composition may also include a crosslinking agent and/or a moisture resistant agent. The binder composition has a light color after curing and may be cured at a temperature that is lower than a curing temperature of a conventional formaldehyde-based binder.

It is an advantage of the present invention that the protein-based biomass is a protein-containing biomass that is natural in origin and derived from renewable resources.

It is another advantage of the present invention that formaldehyde emission from insulation products can be reduced and worker safety can be improved at a low cost to the manufacturer due to the low price of the protein-based compounds.

It is a further advantage of the present invention that the binder can be cured at temperatures lower than conventional formaldehyde-based binders, thereby reducing manufacturing costs and gaseous emissions.

It is yet another advantage of the present invention that the protein-based biomass is of natural origin and is low in cost.

It is also an advantage of the present invention that insulation products and non-woven mats utilizing the inventive binder composition can be manufactured using current manufacturing lines, thereby saving time and money.

It is a feature of the present invention that soy flour, a protein-based biomass, can be modified to form an aqueous mixture that can be applied by conventional binder applicators, including spray applicators.

It is a further feature of the present invention that the binder can be acidic, neutral, or basic.

It is also a feature of the present invention that the binder has a light color upon curing.

It is another feature of the present invention that the inventive insulation products and non-woven mats have no added formaldehyde.

The foregoing and other objects, features, and advantages of the invention will appear more fully hereinafter from a consideration of the detailed description that follows. It is to be expressly understood, however, that the drawings are for illustrative purposes and are not to be construed as defining the limits of the invention.

### BRIEF DESCRIPTION OF THE DRAWINGS

The advantages of this invention will be apparent upon consideration of the following detailed disclosure of the invention, especially when taken in conjunction with the accompanying drawings wherein:

FIG. 1 is a schematic illustration of the formation of a faced insulation product with a post-cure application of urea onto the insulation blanket prior to the application of a facing layer;

FIG. 2 is a is an elevational view of a manufacturing line for producing a fiberglass insulation product that does not contain a facing material according to at least one exemplary embodiment of the present invention;

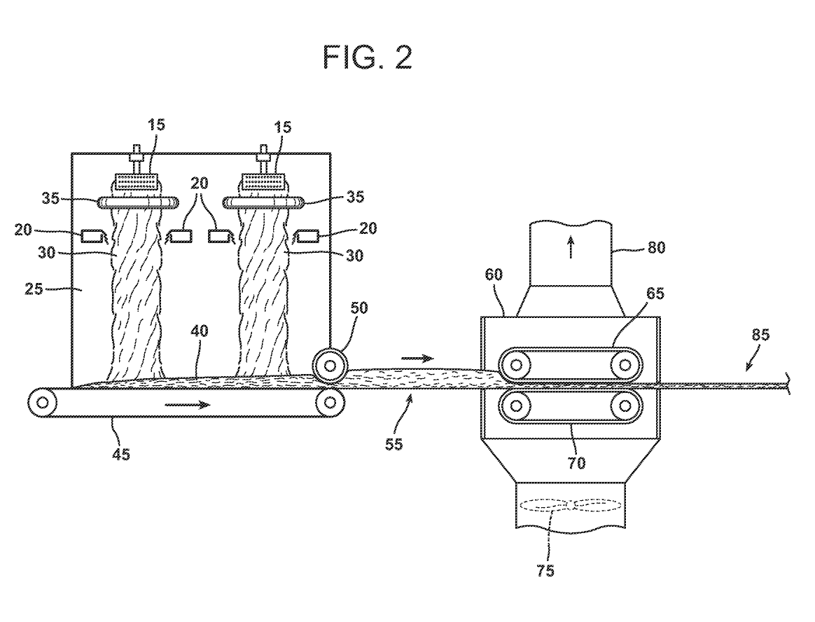

FIG. 3 is a schematic illustration of a wet-laid processing line for forming a chopped strand mat utilizing the inventive binder composition according to at least one exemplary embodiment of the present invention; and

FIG. 4 is a graphical illustration of the Dynamic Mechanical Analysis of a curing test of a binder composition according to at least one exemplary embodiment of the present invention.

### DETAILED DESCRIPTION AND PREFERRED EMBODIMENTS OF THE INVENTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are described herein. All references cited herein, including published or corresponding U.S. or foreign patent applications, issued U.S. or foreign patents, and any other references, are each incorporated by reference in their entireties, including all data, tables, figures, and text presented in the cited references.

In the drawings, the thickness of the lines, layers, and regions may be exaggerated for clarity. It will be understood that when an element such as a layer, region, substrate, or panel is referred to as being “on” another element, it can be directly on the other element or intervening elements may also be present. Also, when an element is referred to as being “adjacent” to another element, the element may be directly adjacent to the other element or intervening elements may be present. The terms “top”, “bottom”, “side”, and the like are used herein for the purpose of explanation only. Like numbers found throughout the figures denote like elements. It is to be noted that the phrase “binder composition”, “binder mixture”, and “binder” may be used interchangeably herein.

The present invention relates to an aqueous binder composition that is protein-based and environmentally friendly. In addition, the binder is free of added formaldehyde. The binder includes a protein-containing biomass and a pH adjuster, and optionally, a crosslinking agent and/or a moisture resistant agent. Additionally, the binder has a light color after it has been cured. The binder may be used in the formation of insulation materials and non-woven chopped strand mats.

In exemplary embodiments, the binder includes at least one protein-containing biomass that is natural in origin and derived from renewable resources. For instance, the protein may be derived from plant sources such as soy (e.g., a soy flour protein), peanuts, sunflowers, kidney beans, walnuts, or from other plants that have a high protein content. Alternatively, the protein may come from animal sources such as, but not limited to, eggs, blood, meat, and fish. In some exemplary embodiments, the protein-containing biomass contains up to about 95% protein, and in other exemplary embodiments, up to 50, 75 or 90% protein. The protein-containing biomass may be present in the binder composition in an amount from about 25% to about 99% by weight of the binder composition, or from about 50% to about 95% by weight.

Additionally, the binder composition contains a pH adjuster in an amount sufficient to adjust the pH to a desired level. The pH may be adjusted depending on the intended application, or to facilitate the compatibility of the ingredients of the size composition. In exemplary embodiments, the pH adjuster is utilized to adjust the pH of the binder composition to an acidic pH. Examples of suitable acidic pH adjusters include mono- or polycarboxylic acids, such as, but not limited to, citric acid, acetic acid, and sulfuric acid, anhydrides thereof, and inorganic salts that can be acid precursors. The acid adjusts the pH, and in some instances, acts as a crosslinking agent. The pH of the binder composition, when in an acidic state, may range from about 1 to about 6, and in some exemplary embodiments, from about 1 to about 5. In at least one exemplary embodiment, the pH of the binder composition is about 1. The pH adjuster in an acidic binder composition may be present in the binder composition in an amount from about 3.0% to about 20% by weight of the binder composition, or from about 5.0% to about 15% by weight.

In another embodiment of the invention, the pH adjuster has a basic pH and is added to the protein-based biomass in an amount sufficient to produce a binder that has a desired, basic pH. Non-limiting examples of suitable basic pH adjusters include sodium bisulfite, sodium hydroxide, potassium hydroxide, and/or ammonium hydroxide. The pH of the binder composition, when in a basic state, may range from about 8 to about 14, or from about 8 to about 12. In at least one exemplary embodiment, the pH of the binder composition is about 10. The basic pH assists in opening the protein structure and improves the adhesion of the protein. The pH adjuster in a basic binder composition may be present in the binder composition in an amount from about 1.0% to about 20% by weight of the binder composition, or from about 2.0% to about 10% by weight.

In a further embodiment of the invention, the binder composition has a neutral pH. In an exemplary embodiment where the binder has a neutral pH, sodium bisulfite and/or urea may be used to break the protein (polymer) bonds present within the protein-based biomass and lower the viscosity of the protein-based biomass. Sodium bisulfite and/or urea may also be added to an acidic binder composition to break the protein bonds, such as is shown below in Example 1. The pH adjuster in a neutral binder composition may be present in the binder composition in an amount from about 0.1 to about 5.0% by weight of the binder composition, or from about 0.5 to about 1.0% by weight.

In addition, the binder composition may contain a crosslinking agent. The crosslinking agent may be any compound suitable for crosslinking the protein-containing biomass and reacting with the moisture resistant agent, when it is present in the binder composition. Non-limiting examples of suitable crosslinking agents include phenols (e.g., tannic acid), resorcinol, polyamines, polyimines, glyoxal, glutardialdehyde, malose, dicarboxylic acid, esters of dicarboxylic acid, polycarboxylic acid, and combinations thereof. The crosslinking agent may be present in the binder composition in an amount up to about 20.0% by weight of the binder composition. In exemplary embodiments, the crosslinking agent may be present in the binder composition in an amount from about 5.0 to about 20.0% by weight of the binder composition, or from about 7.0 to about 15.0% by weight.

The binder composition may also contain a moisture resistant agent, such as a latex, a silicon emulsion, a hydrophobic polymer emulsion (e.g., polyethylene emulsion or polyester emulsion), and mixtures thereof. In at least one exemplary embodiment, the latex system is an aqueous latex emulsion. The latex emulsion includes latex particles that are typically produced by emulsion polymerization. In addition to the latex particles, the latex emulsion may include water, a stabilizer such as ammonia, and a surfactant. The moisture resistant agent may be present in the binder composition in an amount from about 0 to about 50% by weight of the binder composition, or from about 5.0% to about 20% by weight.

There are numerous types of latex that may be used in the latex emulsion. Non-limiting examples of suitable latexes include natural and synthetic rubber resins, and mixtures thereof, including thermosettable rubbers; thermoplastic rubbers and elastomers including, for example, nitrile rubbers (e.g., acrylonitrile-butadiene); polyisoprene rubbers; polychloroprene rubbers; polybutadiene rubbers; butyl rubbers; ethylene-propylene-diene monomer rubbers (EPDM); polypropylene-EPDM elastomers; ethylene-propylene rubbers; styrene-butadiene copolymers; styrene-isoprene copolymers; styrene-butadiene-styrene rubbers; styrene-isoprene-styrene rubbers; styrene-ethylene-butylene-styrene rubbers; styrene-ethylene-propylene-styrene rubbers; polyisobutylene rubbers; ethylene vinyl acetate rubbers; silicone rubbers including, for example, polysiloxanes; methacrylate rubbers; polyacrylate rubbers including, for example, copolymers of isooctyl acrylate and acrylic acid; polyesters; polyether esters; polyvinyl chloride; polyvinylidene chloride; polyvinyl ethers; polyurethanes and blends; acrylates such as methyl acrylates and buthyl acrylates; and combinations thereof.

The binder may optionally contain conventional additives such as, but not limited to dyes, pigments, oils, fillers, colorants, UV stabilizers, thermal stabilizers, anti-foaming agents, anti-oxidants, emulsifiers, and mixtures thereof. Other additives may be added to the binder composition for the improvement of process and product performance. Such additives include coupling agents (e.g., silane, aminosilane, and the like), dust suppression agents, lubricants, wetting agents, surfactants, antistatic agents, and/or water repellent agents. Additives may be present in the binder composition from trace amounts (such as <about 0.1% by weight the binder composition) up to about 10.0% by weight of the binder composition. In some exemplary embodiments, the additives are present in an amount from about 0.1% to about 5.0% by weight of the binder composition.

The binder further includes water to dissolve or disperse the active solids for application onto the reinforcement fibers. Water may be added in an amount sufficient to dilute the aqueous binder composition to a viscosity that is suitable for its application to the reinforcement fibers and to achieve a desired solids content on the fibers. In particular, the binder composition may contain water in an amount from about 78.0 to about 98.0% by weight of the total binder composition.

The binder composition may be made by dispersing the protein-based biomass in water to form a protein stock. The protein stock may then be mixed with the pH adjuster (e.g., acid or base) and the crosslinking agent to form the binder. The binder composition may be further diluted with water to obtain a desired amount of solids. If necessary, the pH of the mixture may be adjusted to the desired pH level.

In the broadest aspect of the invention, the binder composition is formed of a protein-based biomass (e.g., soy flour protein) and a pH adjuster (e.g., an acid such as citric acid or a base such as sodium hydroxide). The range of components used in the inventive binder composition according to other embodiments of the invention is set forth in Table 1.

TABLE 1

| Component | % By Weight |
|---|---|
| Protein-based Biomass | 25-99 |
| pH Adjuster | |
| acid | 3.0-20 |
| base | 1.0-20 |
| neutral | 0.1-5.0 |
| Crosslinking Agent | 0-20 |
| Moisture Resistant Additive | 0-50 |

Aqueous binder compositions according to further exemplary embodiments of the present invention are set forth in Table 2.

TABLE 2

| Component | % By Weight |
|---|---|
| Protein-based Biomass | 50-95 |
| pH Adjuster | |
| acid | 5.0-15 |
| base | 2.0-10 |
| neutral | 0.5-1.0 |
| Crosslinking Agent | 5.0-20 |
| Moisture Resistant Additive | 5.0-20 |

In one exemplary embodiment, the binder composition is used to form an insulation product. Fibrous insulation products are generally formed of matted inorganic fibers bonded together by a cured thermoset polymeric material. Examples of suitable inorganic fibers include glass fibers, wool glass fibers, and ceramic fibers. Optionally, other reinforcing fibers such as natural fibers and/or synthetic fibers such as polyester, polyethylene, polyethylene terephthalate, polypropylene, polyamide, aramid, and/or polyaramid fibers may be present in the insulation product in addition to the glass fibers. The term “natural fiber” as used in conjunction with the present invention refers to plant fibers extracted from any part of a plant, including, but not limited to, the stem, seeds, leaves, roots, or phloem. Examples of natural fibers suitable for use as the reinforcing fiber material include basalt, cotton, jute, bamboo, ramie, bagasse, hemp, coir, linen, kenaf, sisal, flax, henequen, and combinations thereof. Insulation products may be formed entirely of one type of fiber, or they may be formed of a combination of types of fibers. For example, the insulation product may be formed of combinations of various types of glass fibers or various combinations of different inorganic fibers and/or natural fibers depending on the desired application for the insulation. The embodiments described herein are with reference to insulation products formed entirely of glass fibers.

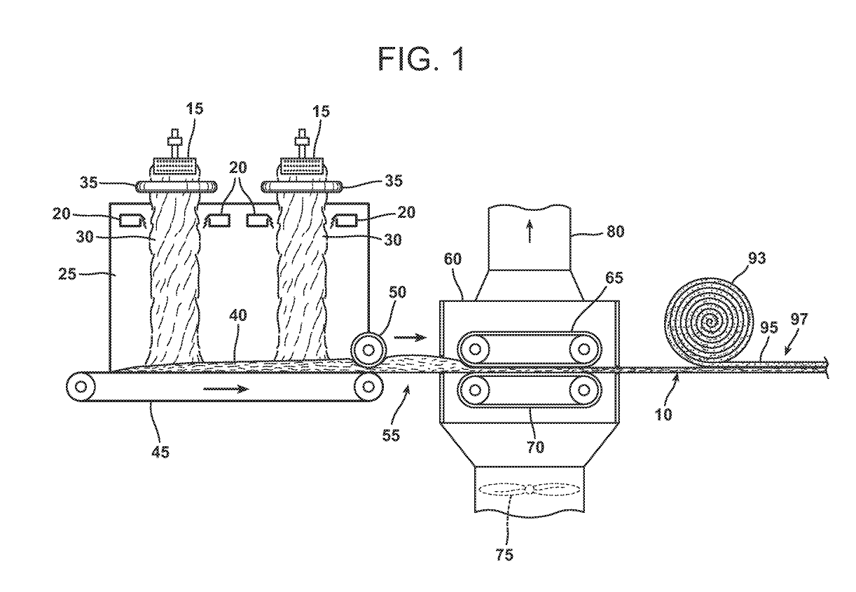

The manufacture of glass fiber insulation may be carried out in a continuous process by fiberizing molten glass, immediately forming a fibrous glass batt on a moving conveyor, and curing the binder on the fibrous glass insulation batt to form an insulation blanket as depicted in FIG. 1. Glass may be melted in a tank (not shown) and supplied to a fiber forming device such as a fiberizing spinner 15. The spinners 15 are rotated at high speeds. Centrifugal force causes the molten glass to pass through holes in the circumferential sidewalls of the fiberizing spinners 15 to form glass fibers. Glass fibers 30 of random lengths may be attenuated from the fiberizing spinners 15 and blown generally downwardly, that is, generally perpendicular to the plane of the spinners 15, by blowers 20 positioned within a forming chamber 25. It is to be appreciated that the glass fibers 30 may be the same type of glass or they may be formed of different types of glass. It is also within the purview of the present invention that at least one of the fibers 30 formed from the fiberizing spinners 15 is a dual glass fiber where each individual fiber is formed of two different glass compositions.

The blowers 20 turn the fibers 30 downward to form a fibrous batt 40. The glass fibers 30 may have a diameter from about 2 to about 9 microns, or from about 3 to about 6 microns. The small diameter of the glass fibers 30 helps to give the final insulation product a soft feel and flexibility.

The glass fibers, while in transit in the forming chamber 25 and while still hot from the drawing operation, are sprayed with the inventive aqueous binder composition by an annular spray ring 35 so as to result in a distribution of the binder composition throughout the formed insulation pack 40 of fibrous glass. Water may also be applied to the glass fibers 30 in the forming chamber 25, such as by spraying, prior to the application of the formaldehyde-based binder composition to at least partially cool the glass fibers 30. The binder may be present in an amount from less than or equal to 4.0% by weight of the total product. The low amount of binder contributes to the flexibility of the final insulation product.

The glass fibers 30 having the uncured resinous binder adhered thereto may be gathered and formed into an uncured insulation pack 40 on an endless forming conveyor 45 within the forming chamber 25 with the aid of a vacuum (not shown) drawn through the fibrous pack 40 from below the forming conveyor 45. The residual heat from the glass fibers 30 and the flow of air through the fibrous pack 40 during the forming operation are generally sufficient to volatilize a majority of the water from the binder before the glass fibers 30 exit the forming chamber 25, thereby leaving the remaining components of the binder on the fibers 30 as a viscous or semi-viscous high-solids liquid.

The coated fibrous pack 40, which is in a compressed state due to the flow of air through the pack 40 in the forming chamber 25, is then transferred out of the forming chamber 25 under exit roller 50 to a transfer zone 55 where the pack 40 vertically expands due to the resiliency of the glass fibers. The expanded insulation pack 40 is then heated, such as by conveying the pack 40 through a curing oven 60 where heated air is blown through the insulation pack 40 to evaporate any remaining water in the binder, cure the binder, and rigidly bond the fibers together. Heated air is forced though a fan 75 through the lower oven conveyor 70, the insulation pack 40, the upper oven conveyor 65, and out of the curing oven 60 through an exhaust apparatus 80. The cured binder imparts strength and resiliency to the insulation blanket 10. It is to be appreciated that the drying and curing of the binder may be carried out in either one or two different steps. The two stage (two-step) process is commonly known as B-staging.

Also, in the curing oven 60, the insulation pack 40 may be compressed by upper and lower foraminous oven conveyors 65, 70 to form a fibrous insulation blanket 10. It is to be appreciated that the insulation blanket 10 has an upper surface and a lower surface. In particular, the insulation blanket 10 has two major surfaces, typically a top and bottom surface, and two minor or side surfaces with fiber blanket 10 oriented so that the major surfaces have a substantially horizontal orientation. The upper and lower oven conveyors 65, 70 may be used to compress the insulation pack 40 to give the insulation blanket 10 a predetermined thickness. It is to be appreciated that although FIG. 1 depicts the conveyors 65, 70 as being in a substantially parallel orientation, they may alternatively be positioned at an angle relative to each other (not illustrated).

The curing oven 60 may be operated at a temperature from about 100° C. to about 325° C., or from about 250° C. to about 300° C. The insulation pack 40 may remain within the oven for a period of time sufficient to crosslink (cure) the binder and form the insulation blanket 10. The inventive binder composition cures at a temperature that is lower than the curing temperature of conventional formaldehyde binders. This lower curing temperature requires less energy to heat the insulation pack, and non-woven chopped strand mat described in detail below, which results in lower manufacturing costs.

A facing material 93 is then placed on the insulation blanket 10 to form a facing layer 95. Non-limiting examples of suitable facing materials 93 include Kraft paper, a foil-scrim-Kraft paper laminate, recycled paper, and calendared paper. The facing material 93 may be adhered to the surface of the insulation blanket 10 by a bonding agent (not shown) to form a faced insulation product 97. Suitable bonding agents include adhesives, polymeric resins, asphalt, and bituminous materials that can be coated or otherwise applied to the facing material 93. The faced fibrous insulation 97 may subsequently be rolled for storage and/or shipment or cut into predetermined lengths by a cutting device (not illustrated). Such faced insulation products may be used, for example, as panels in basement finishing systems, as ductwrap, ductboard, as faced residential insulation, and as pipe insulation. It is to be appreciated that, in some exemplary embodiments, the insulation blanket 10 that emerges from the oven 60 is rolled onto a take-up roll or cut into sections having a desired length and is not faced with a facing material 94.

A significant portion of the insulation placed in the insulation cavities of buildings is in the form of insulation blankets rolled from insulation products such as is described above. Faced insulation products are installed with the facing placed flat on the edge of the insulation cavity, typically on the interior side of the insulation cavity. Insulation products where the facing is a vapor retarder are commonly used to insulate wall, floor, or ceiling cavities that separate a warm interior space from a cold exterior space. The vapor retarder is placed on one side of the insulation product to retard or prohibit the movement of water vapor through the insulation product.

The presence of water, dust, and/or other microbial nutrients in the insulation product 10 may support the growth and proliferation of microbial organisms. Bacterial and/or mold growth in the insulation product may cause odor, discoloration, and deterioration of the insulation product 10, such as, for example, deterioration of the vapor barrier properties of the Kraft paper facing. To inhibit the growth of unwanted microorganisms such as bacteria, fungi, and/or mold in the insulation product 10, the insulation pack 40 may be treated with one or more anti-microbial agents, fungicides, and/or biocides. The anti-microbial agents, fungicides, and/or biocides may be added during manufacture or in a post manufacture process of the insulation product 10.

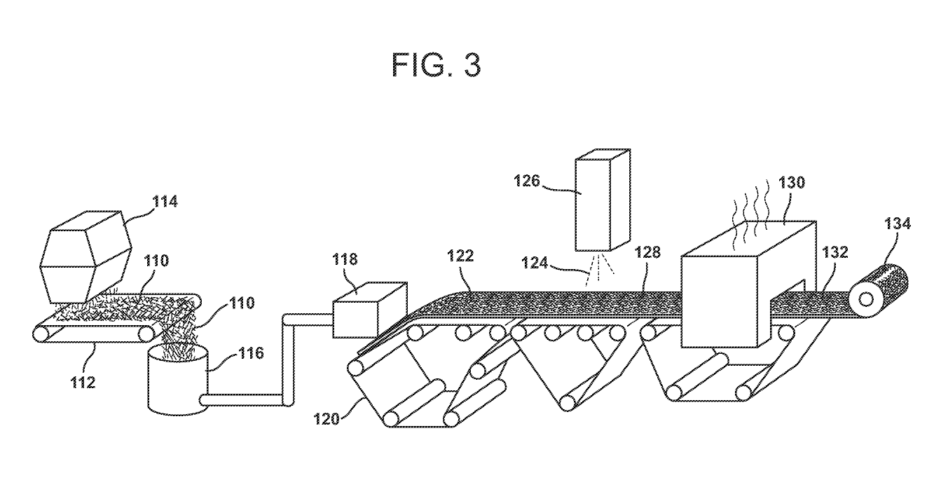

In a second embodiment of the present invention, the binder composition may be used to form a non-woven chopped strand mat. In particular, binder is added during the formation of the chopped strand mat in a wet-laid mat processing line. One exemplary process of separately adding the coupling agent to the chopped strand mat is depicted in FIG. 3. It is to be appreciated that reference is made herein to glass fibers, although the chopped strand mat could be formed of, or include, non-glass fibers. Chopped glass fibers 100 may be provided to a conveying apparatus such as a conveyor 112 by a storage container 114 for conveyance to a mixing tank 116 that contains various surfactants, viscosity modifiers, defoaming agents, and/or other chemical agents with agitation to disperse the fibers and form a chopped glass fiber slurry (not shown). The glass fiber slurry may be transferred to a head box 118 where the slurry is deposited onto a conveying apparatus such as a moving screen or foraminous conveyor 120 and a substantial portion of the water from the slurry is removed to form a web (mat) 122 of enmeshed fibers. The water may be removed from the web 122 by a conventional vacuum or air suction system (not shown).

The inventive binder 124 is applied to the web 122 by a suitable binder applicator, such as the spray applicator 126 or a curtain coater (not illustrated). Once the binder 124 has been applied to the mat 122, the binder coated mat 128 is passed through at least one drying oven 130 to remove any remaining water and cure the binder composition 124. The formed non-woven chopped strand mat 132 that emerges from the oven 130 is an assembly of randomly oriented, dispersed, individual glass fibers. The chopped strand mat 132 may be rolled onto a take-up roll 134 for storage for later use as illustrated.

There are numerous advantages provided by the inventive binder formulation. For example, unlike conventional urea-formaldehyde binders, the binder formulation has a light color after curing. In addition, the protein-based biomass is a protein-containing biomass that is natural in origin and derived from renewable resources. Also, the binder composition can be cured at temperatures lower than conventional formaldehyde-based binders, thereby reducing manufacturing costs and gaseous emissions. By lowering or eliminating formaldehyde emission, the overall volatile organic compounds (VOCs) emitted in the workplace are reduced, and the workplace becomes a safer environment. Additionally, because protein-based biomass compounds are relatively inexpensive, the insulation product or chopped fiber mat can be manufactured at a lower cost.

Having generally described this invention, a further understanding can be obtained by reference to certain specific examples illustrated below which are provided for purposes of illustration only and are not intended to be all inclusive or limiting unless otherwise specified.

### EXAMPLES

### Example 1

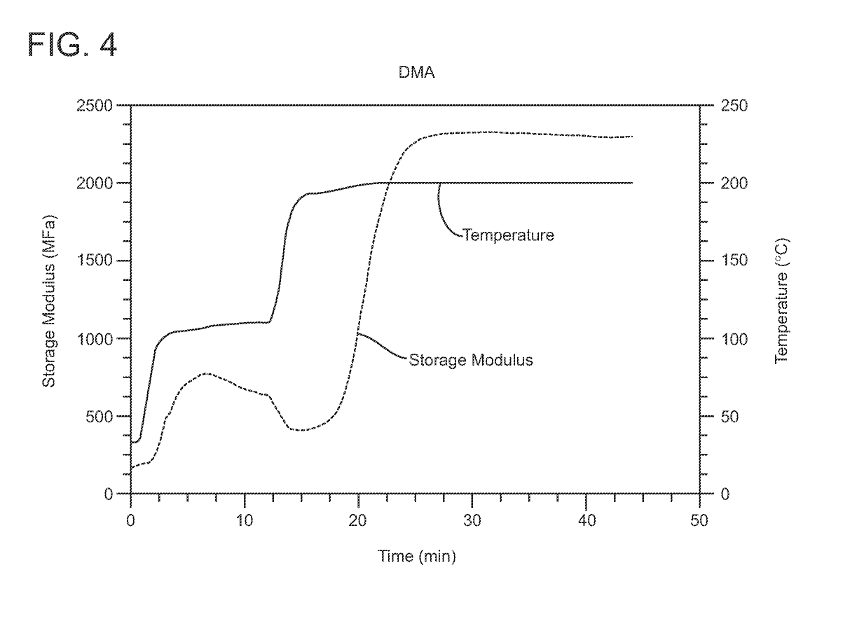

A 20% stock dispersion of soy flour protein in water was prepared with the addition of a small amount of sodium bisulfite to aid in the dispersion. A portion of the protein stock dispersion was mixed with citric acid and tannic acid and further diluted with water to achieve a 22% solids binder mixture containing 71% protein, 23% citric acid, and 6% tannic acid. The binder composition was subjected to a curing test performed by Dynamic Mechanical Analysis (DMA). As illustrated in FIG. 4, the modulus curve demonstrated curing similar to that of standard phenol-formaldehyde binder. Fiberglass handsheets were prepared utilizing the binder composition. Good tensile strength and integrity was observed in the handsheets containing the inventive binder, as can be seen in Table 3.

TABLE 3

| Binder of | Tensile Strength | Tensile % Elongation |
|---|---|---|
| Example 1 | Machine Direction | Machine Direction |
| 12% | 10 | 0.29 |
| 450° F. | | |
| 12% | 12 | 0.30 |
| 400° F. | | |
| 12% | 15 | 0.42 |
| 350° F. | | |

### Example 2

600 g of deionized water, 79.6 g of 20% soy flour (Prolia™ 200/90, commercially available from Cargill), 23.5 g of citric acid solid, and 0.3 g of 2% amino silane (A-1100, commercially available from General Electric) were mixed in a 2000 mL beaker. Additional deionized water was added to the beaker to prepare a total of 800 g of binder mixture. A fiber glass hand sheet was prepared following standard lab procedure. The hand sheet was then coated with the binder and cured in a convection oven for 3 minutes at 450° F. A statistically significant sample size was determined and the samples were measured using an Instron® machine. The average tensile strength was recorded.

Additional binders were prepared in a manner similar to that described above with respect to Example 2. The ratio of components was adjusted to achieve desired LOIs. As used in conjunction with this application, LOI may be defined as the reduction in weight experienced by the fibers after heating them to a temperature sufficient to burn or pyrolyze the organic size from the fibers. LOI may be defined as the percentage of organic solid matter deposited on the reinforcement fiber surfaces. The tensile strengths of handsheets formed and coated with the binders were measured and recorded. The measured tensile strengths were compared using a “normalized tensile” (i.e., tensile strength divided by LOI). These normalized tensile strengths for the handsheets containing the inventive binder are set forth in Table 4. Control samples are set forth in Table 5.

TABLE 4

| Ingredient Percentage | | | | | | | | | |
|---|---|---|---|---|---|---|---|---|---|
| | | | DL | | | | | | |
| Soy | Citric | Tannic | 490 | Kymene | Sodium | A- | | Norm Tensile/LOI | |
| Flour | Acid | Acid | Latex | 736 | Hydroxide | 1100 | pH | Ambient | Steamed |
| 74.8 | 24.9 | | | | | 0.3 | 3-4 | 1.19 | 1.18 |
| 70.4 | 23.5 | 5.9 | | | | 0.3 | 3-4 | 1.08 | 0.7 |
| 59.2 | 19.7 | | 20.8 | | | 0.3 | 3-4 | 2.02 | 1.87 |
| 96.7 | | | | | 3 | 0.3 | 10-10.5 | 1.62 | 1.46 |
| 87.1 | | | | 9.9 | 2.7 | 0.3 | 10-10.5 | 1.93 | 1.76 |
| 87.4 | | | 9.7 | | 2.6 | 0.3 | 10-10.5 | 2.12 | 1.97 |
| 78.5 | | | 9.9 | 8.9 | 2.4 | 0.3 | 10-10.5 | 2.31 | 1.94 |

TABLE 5

| Ingredient Percentage | | | | | | | | | |
|---|---|---|---|---|---|---|---|---|---|
| | | | DL | | | | | | |
| Soy | Citric | Tannic | 490 | Kymene | Sodium | A- | | Norm Tensile/LOI | |
| Flour | Acid | Acid | Latex | 736 | Hydroxide | 1100 | pH | Ambient | Steamed |

| Phenolic Control | | | 1.61 | 1.25 |
|---|---|---|---|---|
| Sucrose Control | 0.3 | 7-8 | 1.46 | 1.36 |

It can be seen from Tables 4 and 5 that the addition of a latex to the binder composition significantly improves the tensile strengths of the handsheets in both ambient and steamed conditions.

The invention of this application has been described above both generically and with regard to specific embodiments. Although the invention has been set forth in what is believed to be the preferred embodiments, a wide variety of alternatives known to those of skill in the art can be selected within the generic disclosure. The invention is not otherwise limited, except for the recitation of the claims set forth below.

Having thus described the invention, what is claimed is:

1. An aqueous binder composition for use in the formation of fiberglass insulation and non-woven mats comprising:
at least one protein-based biomass derived from natural sources; and
at least one pH adjusting agent.

2. The aqueous binder composition of claim 1, wherein:
said protein-based biomass is derived from at least one member selected from soy, peanuts, sunflowers, kidney beans, walnuts, eggs, blood, meat and fish; and
said pH adjuster is selected from citric acid, acetic acid, sulfuric acid, sodium bisulfite, sodium hydroxide, potassium hydroxide, ammonium hydroxide and combinations thereof.

3. The aqueous binder composition of claim 2, wherein said pH adjusting agent adjusts the pH of the binder composition to a range from about 1 to about 6.

4. The aqueous binder composition of claim 2, wherein said pH adjusting agent adjusts the pH of the binder composition to a range from about 8 to about 14.

5. The aqueous binder composition of claim 1, wherein said protein-containing biomass contains up to about 95% protein.

6. The aqueous binder composition of claim 1, further comprising at least one member selected from a crosslinking agent and a moisture resistant agent.

7. The aqueous binder composition of claim 6, wherein said crosslinking agent is selected from phenols, resorcinol, polyamines, polyimines, glyoxal, glutardialdehyde, malose, dicarboxylic acid, esters of dicarboxylic acid, polycarboxylic acid and combinations thereof, and
wherein said moisture resistant agent is selected from latex, a silicon emulsion, a hydrophobic polymer emulsion and mixtures thereof.

8. The aqueous binder composition of claim 1, wherein said binder cures at a temperature that is lower than a curing temperature of a conventional formaldehyde-based binder.

9. A fibrous insulation product comprising:
a plurality of randomly oriented fibers; and
a binder composition applied to at least a portion of said fibers and interconnecting said fibers, said binder composition including:
at least one protein-based biomass derived from natural sources; and
at least one pH adjusting agent, said pH adjusting agent adjusting the pH of said binder composition to a pH from 1 to 14.

10. The fibrous insulation product of claim 9, wherein said protein-containing biomass contains up to about 95% protein.

11. The fibrous insulation product of claim 9, wherein:
said protein-based biomass is derived from at least one member selected from soy, peanuts, sunflowers, kidney beans, walnuts, eggs, blood, meat and fish; and
said pH adjuster is selected from citric acid, acetic acid, sulfuric acid, sodium bisulfite, sodium hydroxide, potassium hydroxide, ammonium hydroxide and combinations thereof.

12. The fibrous insulation product of claim 9, further comprising at least one member selected from a crosslinking agent and a moisture resistant agent.

13. The fibrous insulation product of claim 12, wherein said crosslinking agent is selected from phenols, resorcinol, polyamines, polyimines, glyoxal, glutardialdehyde, malose, dicarboxylic acid, esters of dicarboxylic acid, polycarboxylic acid and combinations thereof, and
wherein said moisture resistant agent is selected from latex, a silicon emulsion, a hydrophobic polymer emulsion and mixtures thereof.

14. The fibrous insulation product of claim 9, wherein said binder cures at a temperature that is lower than a curing temperature of a conventional formaldehyde-based binder.

15. A non-woven chopped strand mat comprising:
a plurality of randomly oriented glass fibers having a discrete length enmeshed in the form of a mat having a first major surface and a second major surface; and
a binder composition at least partially coating said first major surface of said mat, said binder composition including:
at least one protein-based biomass derived from natural sources; and
at least one pH adjusting agent.

16. The non-woven chopped strand mat of claim 15, further comprising at least one member selected from a crosslinking agent and a moisture resistant agent.

17. The non-woven chopped strand mat of claim 16, wherein said binder cures at a temperature that is lower than a curing temperature of a conventional formaldehyde-based binder.

18. The non-woven chopped strand mat of claim 17, wherein said binder composition has a light color after curing.

19. The non-woven chopped strand mat of claim 16, wherein said protein-containing biomass contains up to about 95% protein.

20. The non-woven chopped strand mat of claim 19, wherein:
said protein-based biomass is derived from a member selected from soy, peanuts, sunflowers, kidney beans, walnuts, eggs, blood, meat and fish;
said pH adjuster is selected from citric acid, acetic acid, sulfuric acid, sodium bisulfite, sodium hydroxide, potassium hydroxide, ammonium hydroxide, and combinations thereof,
said crosslinking agent is selected from phenols, resorcinol, polyamines, polyimines, glyoxal, glutardialdehyde, malose, dicarboxylic acid, esters of dicarboxylic acid, polycarboxylic acid and combinations thereof; and
said moisture resistant agent is selected from latex, a silicon emulsion, a hydrophobic polymer emulsion and mixtures thereof.
